(19) United States
(12) Patent Application Publication
(10) Pub. No.: US 2003/0095496 A1
(43) Pub. Date: May 22, 2003

(54) Device for stabilizing the rotating speed of a record player

(75) Inventor: Jin Yi Huang, Tainan Hsien (TW)

Correspondence Address: BACON & THOMAS, PLLC, 625 SLATERS LANE, FOURTH FLOOR, ALEXANDRIA, VA, 22314

(73) Assignee: Ya Horng Electronic Co., Ltd., Tainan Hsien (TW)

(21) Appl. No.: 10/067,249

(22) Filed: Feb. 7, 2002

(30) Foreign Application Priority Data
Nov. 20, 2001 (TW) 90219998

(51) Int. Cl. G11B 5/52; G11B 7/00; G11B 11/03; G11B 11/105; G11B 11/11; G11B 11/115; G11B 11/12; G11B 15/18; G11B 15/46; G11B 15/467; G11B 15/48; G11B 20/18; G11B 27/36; G11B 20/00; G11B 23/00; G11B 25/00

(52) U.S. Cl. 369/266; 369/53.43; 369/53.3

(57) ABSTRACT

A device for stabilizing the rotating speed of a record player has a passive element fitted on the same shaft of a rotating, disk, which activates a record to rotate together. The passive element is formed with a surface expanding outward from a center portion fitted with a shaft and having its outer annular portion engraved with annular minute net holes. A sensor facing the positions of the net holes is provided under a printed circuit board for detecting the change of the shifting speed of the net holes. The signal data detected by the sensor is fed to a micro-processor to carry on operation, and after that, the value of the signal data is transmitted back and automatically modulates the voltage supplied to the rotating disk to let the rotating disk and the record rotate steadily.

### BACKGROUND OF THE INVENTION

This invention relates to a device for stabilizing rotating speed of a record player, particularly to one able to keep a record rotating at a steady speed to permit the music data on the record to be read incessantly without any time buffering error so as to keep good quality of music broadcasting.

Generally, the device for controlling the rotating speed of a record player, as shown in FIG. 1, includes a rotating disk 10 and a printed circuit board 20 combined together. The rotating disk 10 is formed with an inner recessed hollow interior at the bottom side, having a shaft 11 disposed extending up in the center and a permanent magnet 12 fixed around the inner recessed side wall. The printed circuit board 20 is provided with a hollow shaft holder 21 for the shaft 11 of the rotating disk 10 to be axially fitted therein, and a drive coil 22 connected in a Y-shaped mode and corresponding to the permanent magnet 12 of the rotating disk 10. When the drive coil 22 is electrified, there generates a magnetic field to drive the rotating disk 10 to rotate together with the record. Therefore, different voltages supplied to the coil 22 give rise to different strengths of the magnetic field, and thus, the rotating speed of the rotating disk 10 as well as the record can be controlled.

The best way of keeping a record rotating steadily at a definite rotating speed is to control the feed-back signals of the rotating disk 10 and then track and modulate them so as to correct the rotating speed of the rotating disk 10 any time to ensure its steady rotating.

A conventional device for stabilizing the rotation speed of a rotating disk includes an annular permanent magnet 13 installed around the bottom circumferential edge of a rotating disk 10, and an annular teeth-like coil 23 with a concave-convex shape provided around a printed circuit board 20 to match with the permanent magnet 13 of the rotating disk 10, with a gap formed between the coil 23 and the permanent magnet 13, as shown in FIGS. 2 and 3. Thus, when the rotating disk 10 is driven to rotate, its rotating condition can be detected any time through the intervals between every two teeth of the coil 23, and the signal value detected is transmitted to a speed correcting device (a phase lock system available), and after operation, a proper voltage is supplied to the drive coil 22 to control the rotating disk 10 rotate steadily all the time.

However, the foresaid coil 23 is teeth-shaped with a manifest interval between every two teeth, so it will take a comparatively long time for the signal value to be transmitted back, and under such condition, the rotating speed of the rotating disk 10 can hardly be corrected precisely, and in consequence, the rotating disk 10 and its record fail to rotate steadily, resulting in imperfections in music broadcasting. Besides, the coil 23 and the permanent magnet 13 have to be provided respectively on the printed circuit board 20 and at the bottom side of the rotating disk 10, thus increasing producing cost and labor.

### SUMMARY OF THE INVENTION

The objective of the invention is to offer a device for stabilizing the rotating speed of a record player to keep a good quality of music broadcasting.

### BRIEF DESCRIPTION OF DRAWINGS

FIG. 1 is an exploded perspective view of a conventional device for controlling the rotating speed of a record player;

FIG. 2 is a perspective view of the conventional device for controlling the rotating speed of a record player;

FIG. 3 is cross-sectional view of the conventional device for controlling the rotating speed of a record player;

FIG. 4 is an exploded perspective view of an embodiment of a device for stabilizing the rotating speed of a record player in the present invention;

FIG. 5 is a perspective view of the embodiment of the device for stabilizing the rotating speed of a record playerin the present invention;

FIG. 6 is a cross-sectional view of the embodiment of the device for stabilizing the rotating speed of a record player in the present invention; and, FIG. 7 is a partially magnified cross-sectional view of the embodiment of the device for stabilizing the rotating speed of a record player in the present invention.

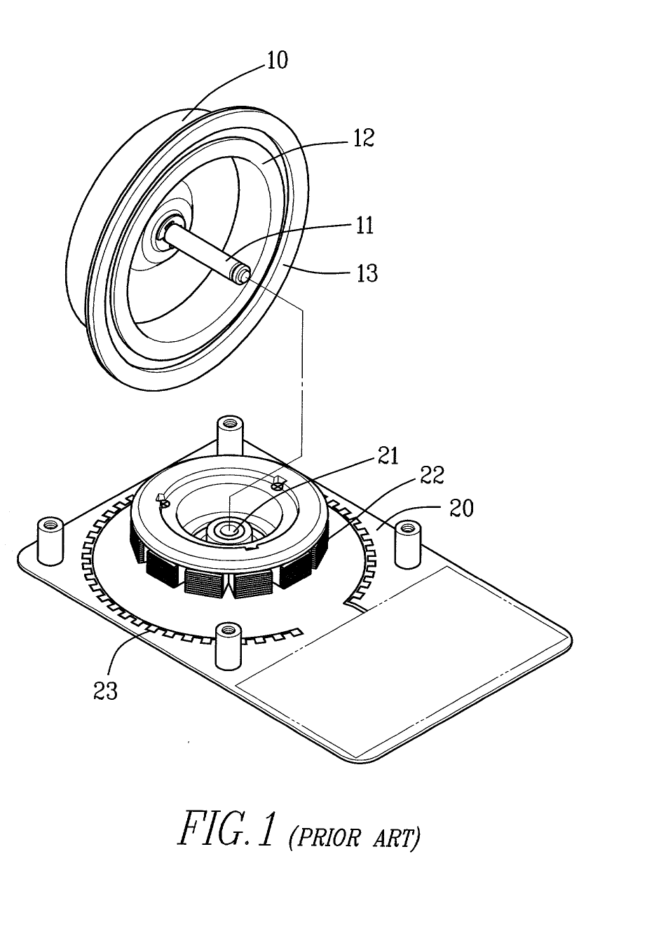

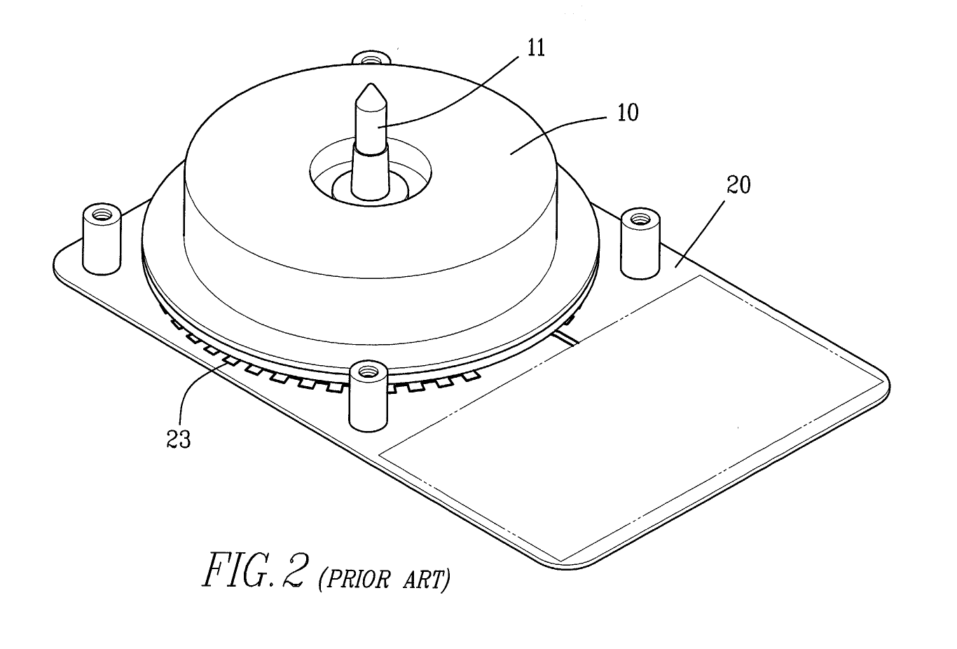

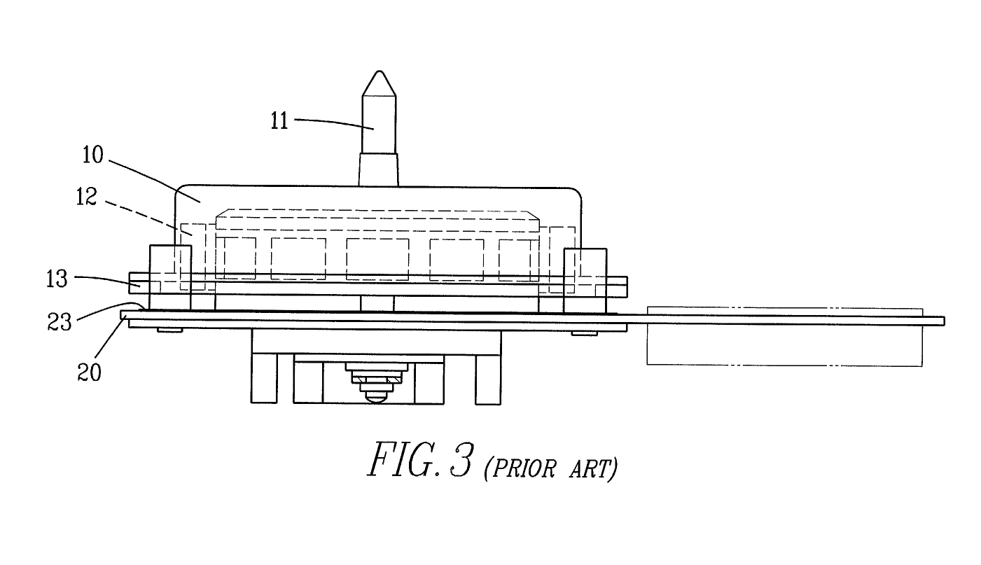

### DETAILED DESCRIPTION OF THE PREFERRED EMBODIMENT

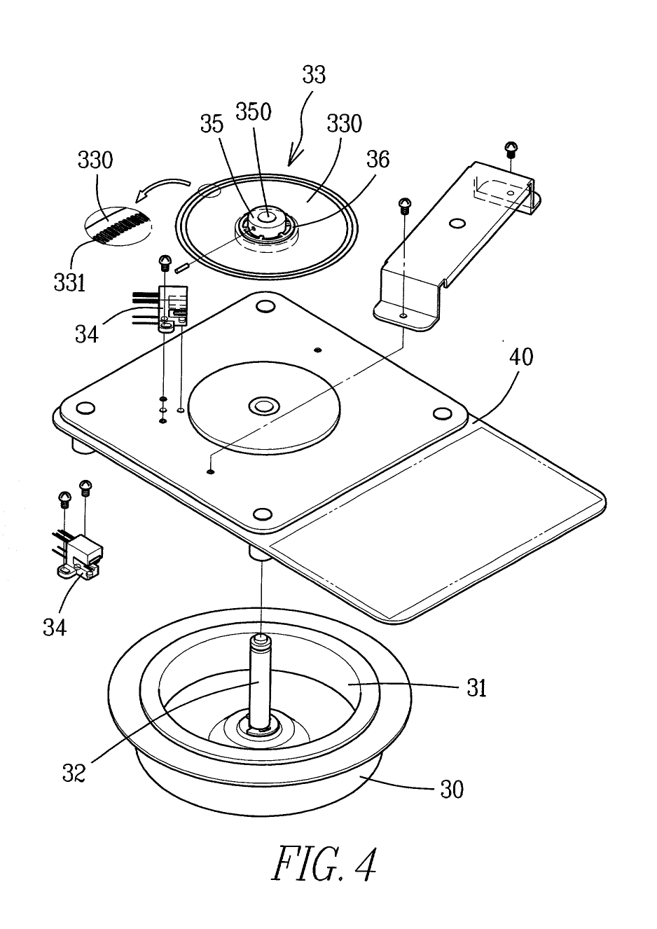

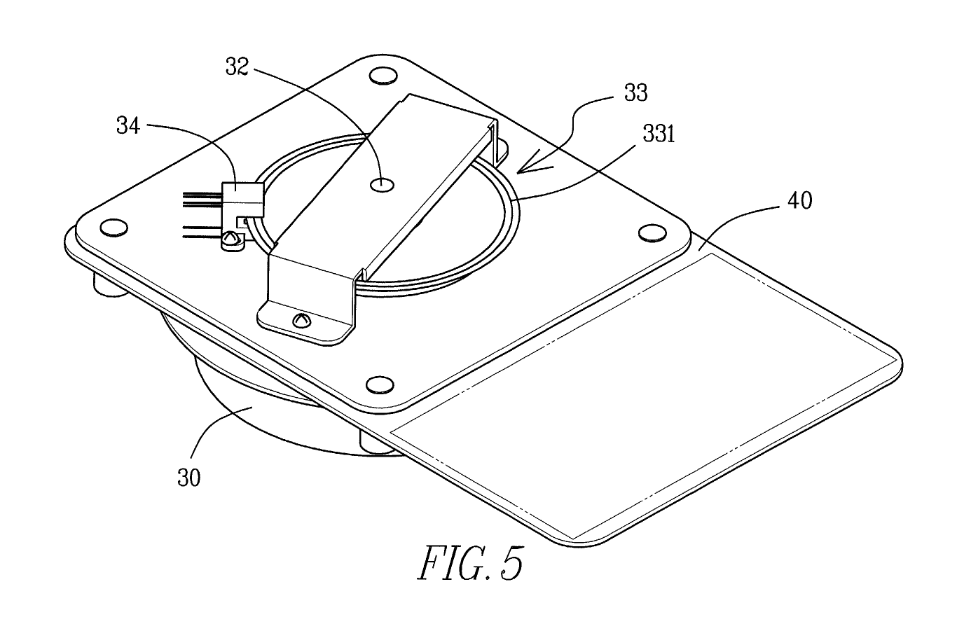

A preferred embodiment of a device for stabilizing the rotating speed of a record player in the present invention, as shown in FIGS. 4 and 5, includes a rotating disk 30, a printed circuit board 40, a passive element 33 and a sensor 34 as main components combined together.

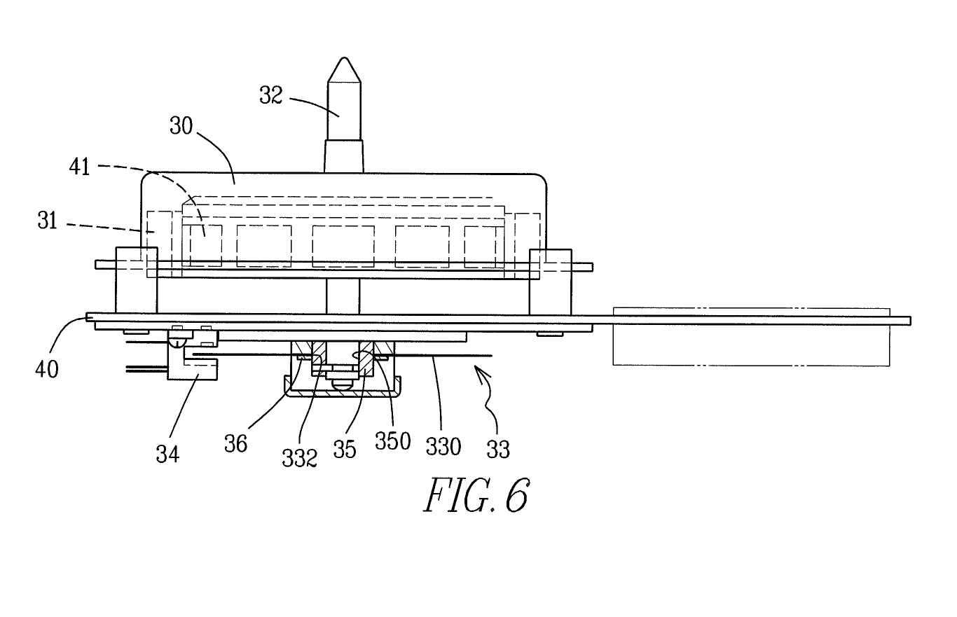

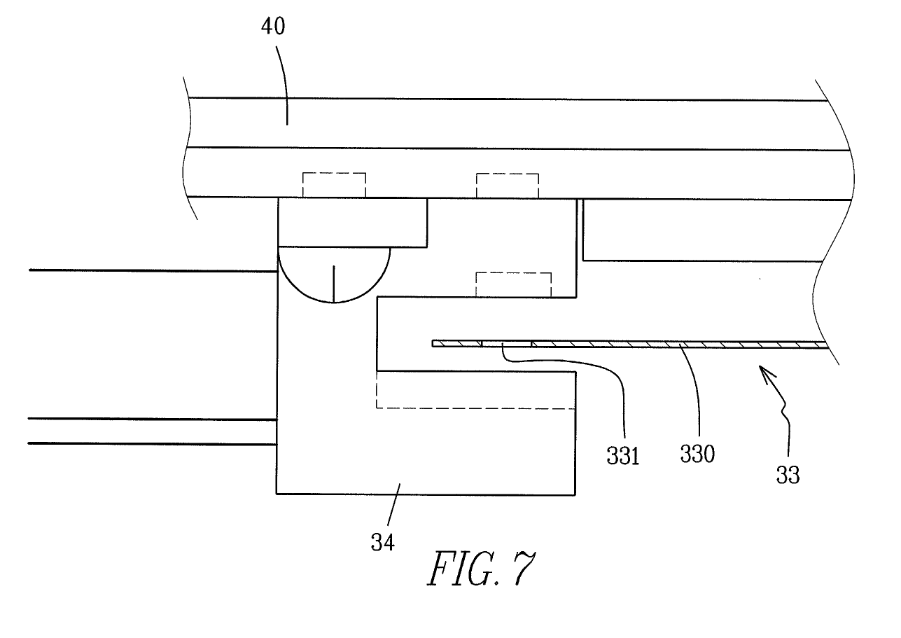

The rotating disk 30 is fixed with an annular permanent magnet 31 around the inner side wall to match with the drive coil 41 of the printed circuit board 40, as shown in FIG. 6, thus after the drive coil 41 is powered, there will generate a magnetic field to drive the rotating disk 30 to rotate. The rotating disk 30 further has a shaft 32 fixedly fitted in the center, with the topside of the rotating disk 30 rotating together with a record. In such case, the rotating speed of the record can surely be kept steady so long as the rotating speed of the rotating disk 30 is properly controlled.

The passive element 33 is fitted around the shaft 32 at the lower side of the rotating disk 30 to be coaxially rotated together with the rotating disk 30, as shown in FIGS. 4 and 6. The passive element 33 has a round surface 330 expanding outward from a center portion fitted with a shaft, and the surface 330 has it outer annular portion engraved with annular minute net holes 331.

The sensor 34 facing the positions of the net holes 331 of the face 330 of the passive element 33 is provided under the printed circuit board 40 for detecting the rotating speed of the passive element 33, as shown in FIGS. 6 and 7. The signal data detected by the sensor 34 is transmitted to a micro-processor to carry on operation, and afterward the value of the signal data is transmitted back to the voltage of the drive coil 20 voltage connected in a Δ-shaped way. Thus, the voltage value of the coil 41 can control the rotating disk 30 any time to let it rotate steadily.

In addition, the passive element 33 is a round metallic sheet, as shown in FIGS. 4, 6 and 7, and is provided with a shaft hole 332 in the center for a projecting shaft member 35 having a hollow interior and a shaft hole 350 to be fitted and fastened therein by means of a clamp 36. Then, the shaft member 35 has its shaft hole 350 axially fixed with the shaft 32 of the rotating disk 30 to let this metallic sheet activated to move by the rotating disk 30.

Further, once the rotating disk 30 rotates excessively fast or slowly, the sensor 34 can detect the change of the shifting speed of the net holes 331 of the passive element 33, and obtain a precise and incessant signal of numerical value through the net holes 331 of high density and minute intervals. Therefore, the rotating speed of the rotating disk 30 and the record can be kept steady all the time.

As can be understood from the above description, the device of the invention is not only able to elevate the steadiness of the rotating speed of a record, but also convenient in assembling and having good practicability.

While the preferred embodiment has been described above, it will be recognized and understood that various modifications may be made therein and the appended claims are intended to cover all such modifications that may fall within the spirit and scope of the invention.

I claim

1. A device for stabilizing the rotating speed of a record player comprising a rotating disk and a printed circuit board:
Said rotating disk formed with an inner recessed hollow interior and having a shaft stably inserted in the center, said rotating disk further fixed with a permanent magnet around its inner circumferential side wall:
Said printed circuit board provided with a shaft holder for said shaft of said rotating disk to be axially inserted therein, said printed circuit board fixed with a drive coil corresponding to said permanent magnet of said rotating disk, a magnetic field generated to drive said rotating disk to rotate together with a record on it after said coil makes electric connection: and,
Characterized by a passive element fitted on the same shaft of said rotating disk, said passive element formed with a round surface expanding outward from a center portion fitted with a shaft, said round surface having its outer annular portion engraved with annular minute net holes, a sensor provided under said printed circuit board and facing the position of said net holes for detecting the change of the shifting speed of said net holes, signal data detected by said sensor transmitted to a micro-processor to carry on operation, the value of said signal data transmitted back, and automatically modulating and changing the voltage value supplied to said drive coil of said printed circuit board, said drive coil connected in a Δ-shaped way, the rotating speed of said rotating disk controlled any time by said feed-back signals so as to rotate steadily together with the record all the time.

2. The device for stabilizing the rotating speed of a record player as claimed in claim 1, wherein said passive element is a round metallic sheet having a shaft bole formed in the center for a projecting shaft member having an interior hollow shape and a shaft hole to be fitted and secured therein by a clamp.
